(19) United States
(12) Patent Application Publication
(10) Pub. No.: US 2015/0064382 A1
(43) Pub. Date: Mar. 5, 2015

(54) COMPOSITION AND ARTICLE COMPRISING THERMOPLASTIC POLYURETHANE AND PARTICULATE ENGINEERING POLYMER

(71) Applicant: SABIC Innovative Plastics IP B.V., Bergen op Zoom (NL)

(72) Inventor: Edward Norman Peters, Lenox, MA (US)

(21) Appl. No.: 14/015,044

(22) Filed: Aug. 30, 2013

(51) Int. Cl. C08L 75/04

(52) U.S. Cl. CPC C08L 75/04
USPC 428/36.92; 525/453; 525/424

(57) ABSTRACT

A composition includes 50 to 95 weight percent of a thermoplastic polyurethane, and 5 to 50 weight percent of a particulate engineering plastic. The particulate engineering plastic has a glass transition temperature or a crystalline melting point greater than or equal to 200° C. and includes a polyarylsulfone, a polyimide, a poly(phenylene sulfide), a semi-crystalline polyamide, or a combination thereof. Incorporation of the particulate engineering plastic into the thermoplastic polyurethane improves one or more of tensile strength, heat resistance, hardness, and char formation.

### BACKGROUND OF THE INVENTION

Thermoplastic polyurethanes are prepared from polymeric diols (often referred to as “polyols”) and diisocyanates. The Polyurethanes Book, Randall, D., Lee, S., John Wiley & Sons, New York, 2003. Uhlig, K., Discovering Polyurethanes, Hanser Gardner: New York, 1999. The isocyanate groups of the diisocyanate react with the hydroxyl groups of the polymeric diol to form a urethane bond. In general, the polymeric diol can be a low molecular weight polyether or polyester. The diisocyanate can be aliphatic or aromatic.

Thermoplastic polyurethanes are elastomers that are fully thermoplastic. Like all thermoplastic elastomers, thermoplastic polyurethanes are elastomeric and melt-processable. The generally recognized useful features of thermoplastic polyurethanes include high impact strength even at low temperatures, high elongation, good abrasion resistance, excellent heat resistance, excellent resistance to non-polar solvents and fuels and oils, resistance to ozone and oxidation and humidity, and good electrical properties. However, for some applications, thermoplastic polyurethanes exhibit inadequate performance in one or more of tensile strength, heat resistance, hardness, and char formation during combustion.

There is therefore a need for thermoplastic polyurethanes exhibiting improved performance in one or more of tensile strength, heat resistance, hardness, and char formation.

### BRIEF SUMMARY OF EMBODIMENTS OF THE INVENTION

One embodiment is a composition comprising: 50 to 95 weight percent of a thermoplastic polyurethane; and 5 to 50 weight percent of a particulate engineering plastic; wherein the particulate engineering plastic comprises a polyarylsulfone, a polyimide, a poly(phenylene sulfide), a semi-crystalline polyamide, or a combination thereof; wherein the particulate engineering plastic has a glass transition temperature or a crystalline melting point greater than or equal to 200° C.; wherein the particulate engineering plastic has a mean particle size of 5 to 1000 micrometers; and wherein the weight percent values are based on the total weight of the composition.

Another embodiment is an article comprising the composition.

These and other embodiments are described in detail below.

### BRIEF DESCRIPTION OF THE DRAWINGS

FIG. 1 is a scanning electron micrograph of a chloroform-etched surface of the Example 3 composition comprising a particulate polyethersulfone in thermoplastic polyurethane.

FIG. 2 is a scanning electron micrograph of a chloroform-etched surface of an article molded from the Example 6 composition comprising a particulate polyetherimide in thermoplastic polyurethane.

FIG. 3 is a scanning transmission electron micrograph of a RuO₄/OsO₄-stained surface of an article molded from the Example 7 composition comprising a particulate poly(phenylene sulfide) in thermoplastic polyurethane.

### DETAILED DESCRIPTION OF THE INVENTION

The present inventor has determined that improvements in one or more of tensile strength, heat resistance, hardness, and char formation can be imparted to thermoplastic polyurethanes by incorporating particulate engineering thermoplastics. Thus, one embodiment is a composition comprising: 50 to 95 weight percent of a thermoplastic polyurethane; and 5 to 50 weight percent of a particulate engineering plastic; wherein the particulate engineering plastic comprises a polyarylsulfone, a polyimide, a poly(phenylene sulfide), a semi-crystalline polyamide, or a combination thereof; wherein the particulate engineering plastic has a glass transition temperature or a crystalline melting point greater than or equal to 200° C.; wherein the particulate engineering plastic has a mean particle size of 5 to 1000 micrometers; and wherein the weight percent values are based on the total weight of the composition.

The composition comprises a thermoplastic polyurethane. Thermoplastic polyurethanes are prepared by the reacting a diisocyanate and a polymeric diol in a bulk or solution polymerization process that results in linear polymeric chains combined in block structures. A variety of diisocyanates and diols are used to produce elastomers that can range from hard and stiff to soft and flexible. The finished elastomers are supplied as granules or pellets for processing by traditional thermoplastic processing techniques such as extrusion, injection molding and calendering.

Examples of diisocyanates that can be used in the polyurethane-forming reaction include 1,4-tetramethylene diisocyanate, 1,6-hexamethylene diisocyanate, 2,2,4-trimethyl-1,6-hexamethylene diisocyanate, 1,12-dodecamethylene diisocyanate, cyclohexane-1,3-diisocyanate, and cyclohexane-1,4-diisocyanate, 1-isocyanato-2-isocyanatomethyl cyclopentane, 1-isocyanato-3-isocyanatomethyl-3,5,5-trimethyl-cyclohexane (isophorone diisocyanate or IPDI), bis(4-isocyanatocyclohexyl)methane, 2,4′-dicyclohexyl-methane diisocyanate, 1,3-bis(isocyanatomethyl)-cyclohexane, 1,4-bis-(isocyanatomethyl)-cyclohexane, bis(4-isocyanato-3-methyl-cyclohexyl)methane, alpha,alpha,alpha′,alpha′-tetramethyl-1,3-xylylene diisocyanate, alpha,alpha,alpha′,alpha′-tetramethyl-1,4-xylylene diisocyanate, 1-isocyanato-1-methyl-4(3)-isocyanatomethyl cyclohexane, 2,4-hexahydrotoluene diisocyanate, 2,6-hexahydrotoluene diisocyanate, 1,3-phenylene diisocyanate, 1,4-phenylene diisocyanate, 2,4-toluene diisocyanate, 2,6-toluene diisocyanate, 2,4-diphenylmethane diisocyanate, 4,4′-diphenylmethane diisocyanate (MDI), 1,5-diisocyanato naphthalene, and mixtures thereof. In some embodiments, the diisocyanate comprises 1,6-hexamethylene diisocyanate, 1-isocyanato-3-isocyanatomethyl-3,5,5-trimethylcyclohexane (isophorone diisocyanate or IPDI), bis-(4-isocyanatocyclohexyl)methane, alpha,alpha,alph′,alpha′-tetramethyl-1,3-xylylene diisocyanate, alpha,alpha,alph′,alpha′-tetramethyl-1,4-xylylene diisocyanate, 1-isocyanato-1-methyl-4(3)-isocyanatomethyl cyclohexane, 2,4-hexahydrotoluene diisocyanate, 2,6-hexahydrotoluene diisocyanate, 2,4-toluene diisocyanate, 2,6-toluoylene diisocyanate, 2,4-diphenylmethane diisocyanate, 4,4′-diphenylmethane diisocyanate (MDI), 3,3-dimethyl-4,4-biphenyldiisocyanate, naphthalene-1,5-diisocyanate, 1-isocyanato-3-isocyanatomethyl-3,5,5-trimethylcylohexane, polyphenylene diisocyanate, or a mixture thereof. In some embodiments, the diisocyanate comprises 2,4′-diphenylmethane diisocyanate, 4,4′-diphenylmethane diisocyanate, toluene 2,6-diisocyanate, toluene 2,4-diisocyanate, or a combination thereof.

Examples of polymeric diols that can be used in the polyurethane-forming reaction include polyether diols, polyester diols, and combinations thereof.

Examples of polyether diols include polyethylene ether diols, polypropylene ether diols, polybutylene glycols, polytetramethylene ether diols, ethylene oxide capped polypropylene oxides, and combinations thereof.

Examples of polyester diols include aliphatic polyester diols (sometimes called aliphatic polyester polyols), aromatic polyester diols (sometimes called aromatic polyester polyols), and polycaprolactone diols. It will be understood that aromatic polyester diols include aromatic repeat units and can, optionally, further include aliphatic repeat units, as in poly(ethylene terephthalate) and poly(butylene terephthalate).

In addition to the diisocyanate and the polymeric diol, the polyurethane-forming reaction can further employ alkylene diols, alkylene ether diols, alkoxylates of aromatic diols, and combinations thereof.

Examples of alkylene diols include 1,2-ethandiol (ethylene glycol), 1,2-propanediol (propylene glycol), 1,4-butanediol, 2-ethyl-1,3-hexanediol, 1,3-butanediol, 2-butyl-2-ethyl-1,3-propanediol, 2,4-diethyl-1,5-pentanediol, ethylene glycol, 1,3-propanediol, 2,3-butanediol, 1,5-pentanediol, 1,6-hexanediol, 2,2,4-trimethyl-1,3-pentanediol, and combinations thereof.

Examples of alkylene ether diols include diethylene glycol, triethylene glycol, tetraethylene glycol, dipropylene glycol, tripropylene glycol, tetrapropylene glycol, dibutylene glycol, tributylene glycol, tetrabutylene glycol, and combinations thereof.

Examples of alkoxylates of aromatic diols include ethoxylated and propoxylated derivatives of hydroquinone, resorcinol, catechol, 1,1-bis(3,5-dimethyl-4-hydroxyphenyl)ethane, 1,1-bis(3-chloro-4-hydroxyphenyl)ethane, 1,1-bis(3-methyl-4-hydroxyphenyl)-ethane, 1,2-bis(4-hydroxy-3,5-dimethylphenyl)-1,2-diphenylethane, 1,2-bis(3-methyl-4-hydroxyphenyl)-1,2-diphenylethane, 1,2-bis(3-methyl-4-hydroxyphenyl)ethane, 2,2′-binaphthol, 2,2′-biphenol, 2,2′-dihydroxy-4,4′-dimethoxybenzophenone, 2,2′-dihydroxy-4-methoxybenzophenone, 2,2′-dihydroxybenzophenone, 2,2-bis(3,5-dichloro-4-hydroxyphenyl)propane, 2,2-bis(3-bromo-4-hydroxyphenyl)propane, 2,2-bis(3-phenyl-4-hydroxyphenyl)propane, 2,2-bis(3-methyl-4-hydroxyphenyl)propane, 2,2-bis(3,5-dimethyl-4-hydroxyphenyl)propane, 1,1-bis(3,5-dimethyl-4-hydroxyphenyl)-1-phenylethane, 1,1-bis(3-chloro-4-hydroxyphenyl)-1-phenylethane, 1,1-bis(3-methyl-4-hydroxyphenyl)-1-phenylethane, 2,2-bis(4-hydroxy-3,5-dimethyl phenyl)-1-phenylpropane, 2,2-bis(4-hydroxy-3,5-dimethyl phenyl)hexane, 2,2-bis(4-hydroxy-3,5-dimethylphenyl)pentane, 2,2-bis(3-methyl-4-hydroxynaphthyl)propane, 2,2-bis(3-methyl-4-hydroxyphenyl)-1-phenylpropane, 2,2-bis(3-methyl-4-hydroxyphenyl)hexane, 2,2-bis(3-methyl-4-hydroxyphenyl)pentane, 2,2′-methylenebis(4-methylphenol), 2,2′-methylenebis[4-methyl-6-(1-methylcyclohexyl)phenol], 3,3′,5,5′-tetramethyl-4,4′-biphenol, 3,3′-dimethyl-4,4′-biphenol, bis(2-hydroxyphenyl)-methane, bis(4-hydroxy-2,6-dimethyl-3-methoxyphenyl)methane, bis(3,5-dimethyl-4-hydroxyphenyl)methane, bis(3-methyl-4-hydroxyphenyl)methane, bis-(4-hydroxy-3,5-dimethyl phenyl)cyclohexylmethane, bis(4-hydroxy-3,5-dimethyl phenyl)phenylmethane, bis(3-methyl-4-hydroxyphenyl)cyclohexylmethane, bis(3-methyl-4-hydroxyphenyl)methane, bis(3,5-dimethyl-4-hydroxyphenyl)methane, bis(3-methyl-4-hydroxyphenyl)phenylmethane, 2,2′,3,3′,5,5′-hexamethyl-4,4′-biphenol, octafluoro-4,4′-biphenol, 2,3,3′,5,5′-pentamethyl-4,4′-biphenol, 1,1-bis(3,5-dibromo-4-hydroxyphenyl)cyclohexane 1,1-bis(3,5-dimethyl-4-hydroxyphenyl)cyclohexane, bis(3-methyl-4-hydroxyphenyl)cyclohexane, tetrabromobiphenol, tetrabromobisphenol A, tetrabromobisphenol S, 2,2′-diallyl-4,4′-bisphenol A, 2,2′-diallyl-4,4′-bisphenol S, 3,3′,5,5′-tetramethyl-4,4′-bisphenol sulfide, 3,3′-dimethyl bisphenol sulfide, and 3,3′,5,5′-tetramethyl-4,4′-bisphenolsulfone.

The weight percent of polymeric diol residue repeat units and diisocyanate residue repeat units in the thermoplastic polyurethane will depend on the molecular weights of the polymeric diol and the diisocyanate from which the thermoplastic polyurethane is formed. In general, the thermoplastic polyurethane will comprise 60 to 95 weight percent of the polymeric diol residue repeat units, and 5 to 40 weight percent of the diisocyanate residue repeat units, based on the weight of the thermoplastic polyurethane.

Reaction mixtures used to prepare thermoplastic polyurethanes are characterized by an isocyanate index, which is calculated according to the equation

$$Isocyanate Index = \frac{{Moles}_{NCO}}{{Moles}_{OH} + {Moles}_{HOH} + {Moles}_{NH}} \times 100$$

wherein Moles_{NCO} is the moles of isocyanate groups in the reaction mixture, Moles_{OH} is the moles of OH groups in the reaction mixture from sources other than water (including OH groups from alcohols and carboxylic acid), Moles_{HoH} is the moles of OH groups in the reaction mixture from water, and Moles_{NH} is the moles of NH groups in the reaction mixture. When the reaction mixture molar ratio of isocyanate groups to hydroxyl groups is 1:1 and no water or NH groups are present in the reaction mixture, the isocyanate index is 100, and a “pure” polyurethane is formed. Reaction mixtures used to form thermoplastic polyurethanes are typically characterized by an isocyanate index less than or equal to 1.0.

In addition to the polymeric diol and the diisocyanate, the thermoplastic polyurethane-forming reaction mixture can include additives such as, for example, catalysts, surfactants, fire retardants, smoke suppressants, fillers and/or reinforcements other than the particulate engineering thermoplastic, antioxidants, UV stabilizers, antistatic agents, infrared radiation absorbers, viscosity reducing agents, pigments, dyes, mold release agents, antifungal agents, biocides, and combinations thereof.

Thermoplastic polyurethanes can also be obtained commercially from companies including BASF (as ELASTOLLAN™ Resins) and Huntsman (as IROGRAN™ IROSTIC™, KRYSTALFLEX™, and AVALON™ Resins).

In some embodiments, the thermoplastic polyurethane has a weight average molecular weight of 10,000 to 250,000 atomic mass units, specifically 50,000 to 250,000 atomic mass units.

The composition comprises 50 to 95 weight percent of the thermoplastic polyurethane, based on the total weight of the composition. Within this range, the thermoplastic polyurethane content can be 60 to 95 weight percent, specifically 70 to 90 weight percent.

In addition to the thermoplastic polyurethane, the composition comprises a particulate engineering plastic. The particulate engineering plastic can be a polyarylsulfone, a polyimide, a poly(phenylene sulfide), a semi-crystalline polyamide, or a combination thereof. All of these engineering plastics have high a glass transition temperature or crystalline melting point. Specifically, the particulate engineering plastic has a glass transition temperature or a crystalline melting point greater than or equal to 200° C. Within this limit, the glass transition temperature or a crystalline melting point can be 200 to 350° C., specifically 250 to 350° C.

The particulate engineering plastic can be a polyarylsulfone. Suitable polyarylsulfones include those comprising repeating units of the formulae

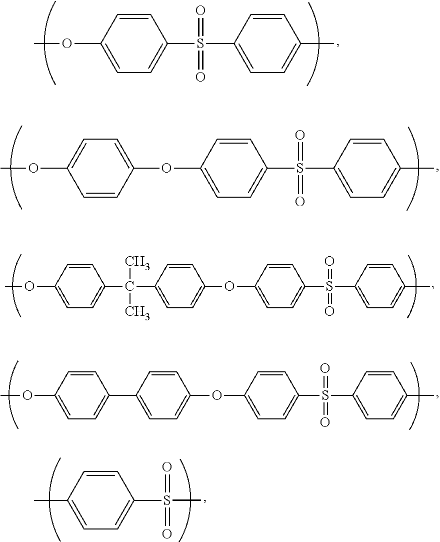

and combinations thereof A variety of polyarylsulfones are commercially available from BASF, Amoco, and ICI.

The particulate engineering plastic can be a polyimide. A polyimide is a polymer comprising a plurality of repeating units having the structure

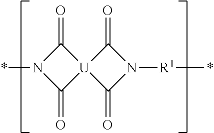

wherein U is independently at each occurrence a tetravalent linker selected from the group consisting of substituted or unsubstituted, saturated, unsaturated, or aromatic monocyclic and polycyclic groups having 5 to 50 carbon atoms, substituted or unsubstituted alkyl groups having 1 to 30 carbon atoms, and substituted or unsubstituted alkenyl groups having 2 to 30 carbon atoms; and R¹ is independently at each occurrence a divalent group selected from the group consisting of substituted or unsubstituted divalent aromatic hydrocarbon moieties having 6 to 20 carbons, straight or branched chain alkylene moieties having 2 to 20 carbons, cycloalkylene moieties having 3 to 20 carbon atom, and divalent moieties of the general formula

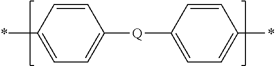

wherein Q is selected from the group consisting of —O—, —S—, —C(O)—, —S(O)₂—, —S(O)—, and —C_{y}H_{2y}— where y is 1 to 20. The number of repeating units in the polyimide can be, for example, 10 to 1,000, specifically 10 to 500.

Exemplary tetravalent linkers, U, include tetravalent aromatic radicals of the formula

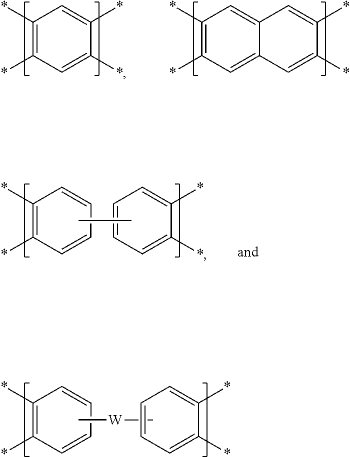

wherein W is a divalent moiety such as —O—, —S—, —C(O)—, —SO₂—, —SO—, —C_{y}H_{2y}— (y being an integer of 1 to 20), and halogenated derivatives thereof, including perfluoroalkylene groups, or a group of the Formula —O—Z—O— wherein the divalent bonds of the —O— or the —O—Z—O— group are in the 3,3′, 3,4′, 4,3′, or the 4,4′ positions, and wherein Z includes divalent moieties of the formula

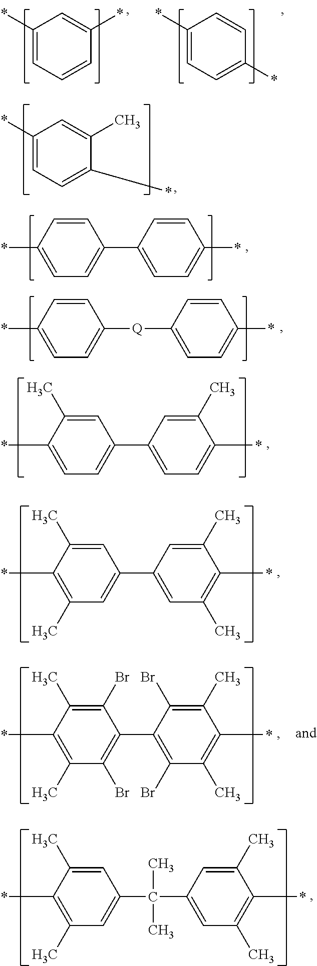

wherein Q is divalent moiety that can be —O—, —S—, —C(O)—, —SO₂—, —SO—, —C_{y}H_{2y}— wherein y is 1 to 8, or —CₚH_{q}Fᵣ— where p is from 1 to 8 and q is 0 to 15 and r is 1 to 16 and q+r=2p. In some embodiments the tetravalent linker U is free of halogens.

In some embodiments, the polyimide comprises a polyetherimide. Polyetherimides comprise repeating units of formula

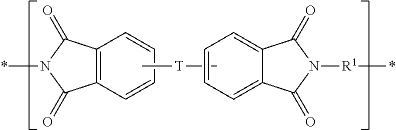

wherein T is —O— or a group of the Formula —O—Z—O— wherein the divalent bonds of the —O— or the —O—Z—O— group are in the 3,3′, 3,4′, 4,3′, or the 4,4′ positions of the phthalimide groups, and wherein Z and R¹ are defined as described above. In some embodiments, each occurrence of R¹ is independently p-phenylene or m-phenylene, and T is a divalent moiety of the formula

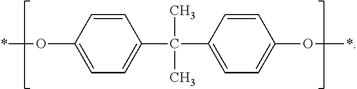

Included among the many methods of making polyimides, including polyetherimides, are those disclosed in U.S. Pat. No. 3,847,867 to Heath et al., U.S. Pat. No. 3,850,885 to Takekoshi et al., U.S. Pat. No. 3,852,242 and U.S. Pat. No. 3,855,178 to White, U.S. Pat. No. 3,983,093 to Williams et al., and U.S. Pat. No. 4,443,591 to Schmidt et al.

In some embodiments, R¹ is independently at each occurrence meta-phenylene or para-phenylene, and U has the structure

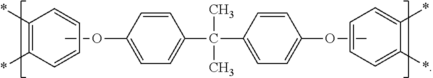

The repeating units of the polyimide are formed by the reaction of a dianhydride and a diamine. Dianhydrides useful for forming the repeating units include those having the formula

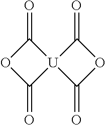

wherein U is as defined above. As mentioned above the term dianhydrides includes chemical equivalents of dianhydrides. In some embodiments, the dianhydride comprises an aromatic bis(ether anhydride). Examples of specific aromatic bis(ether anhydride)s are disclosed, for example, in U.S. Pat. No. 3,972,902 to Heath et al. and U.S. Pat. No. 4,455,410 to Giles. Illustrative examples of aromatic bis(ether anhydride)s include 2,2-bis[4-(3,4-dicarboxyphenoxy)phenyl]propane dianhydride, 4,4′-bis(3,4-dicarboxyphenoxy)diphenyl ether dianhydride, 4,4′-bis(3,4-dicarboxyphenoxy)diphenyl sulfide dianhydride, 4,4′-bis(3,4-dicarboxyphenoxy)benzophenone dianhydride, 4,4′-bis(3,4-dicarboxyphenoxy)diphenyl sulfone dianhydride, 2,2-bis[4-(2,3-dicarboxyphenoxy)phenyl]propane dianhydride, 4,4′-bis(2,3-dicarboxyphenoxy)diphenyl ether dianhydride, 4,4′-bis(2,3-dicarboxyphenoxy)diphenyl sulfide dianhydride, 4,4′-bis(2,3-dicarboxyphenoxy)benzophenone dianhydride, 4,4′-bis(2,3-dicarboxyphenoxy)diphenyl sulfone dianhydride, 4-(2,3-dicarboxyphenoxy)-4′-(3,4-dicarboxyphenoxy)diphenyl-2,2-propane dianhydride, 4-(2,3-dicarboxyphenoxy)-4′-(3,4-dicarboxyphenoxy)diphenyl ether dianhydride, 4-(2,3-dicarboxyphenoxy)-4′-(3,4-dicarboxyphenoxy)diphenyl sulfide dianhydride, 4-(2,3-dicarboxyphenoxy)-4′-(3,4-dicarboxyphenoxy)benzophenone dianhydride, 4-(2,3-dicarboxyphenoxy)-4′-(3,4-dicarboxyphenoxy)diphenyl sulfone dianhydride, and mixtures thereof.

Diamines useful for forming the repeating units of the polyimide include those having the formula

H₂N—R¹—NH₂

wherein R¹ is as defined above. Examples of specific organic diamines are disclosed, for example, in U.S. Pat. No. 3,972,902 to Heath et al. and U.S. Pat. No. 4,455,410 to Giles. Exemplary diamines include ethylenediamine, propylenediamine, trimethylenediamine, diethylenetriamine, triethylenetertramine, hexamethylenediamine, heptamethylenediamine, octamethylenediamine, nonamethylenediamine, decamethylenediamine, 1,12-dodecanediamine, 1,18-octadecanediamine, 3-methylheptamethylenediamine, 4,4-dimethylheptamethylenediamine, 4-methylnonamethylenediamine, 5-methylnonamethylenediamine, 2,5-dimethylhexamethylenediamine, 2,5-dimethylheptamethylenediamine, 2,2-dimethylpropylenediamine, N-methyl-bis(3-aminopropyl)amine, 3-methoxyhexamethylenediamine, 1,2-bis(3-aminopropoxy) ethane, bis(3-aminopropyl) sulfide, 1,4-cyclohexanediamine, bis-(4-aminocyclohexyl) methane, m-phenylenediamine, p-phenylenediamine, 2,4-diaminotoluene, 2,6-diaminotoluene, m-xylylenediamine, p-xylylenediamine, 2-methyl-4,6-diethyl-1,3-phenylenediamine, 5-methyl-4,6-diethyl-1,3-phenylenediamine, benzidine, 3,3′-dimethylbenzidine, 3,3′-dimethoxybenzidine, 1,5-diaminonaphthalene, bis(4-aminophenyl) methane, bis(2-chloro-4-amino-3,5-diethylphenyl) methane, bis(4-aminophenyl) propane, 2,4-bis(p-amino-t-butyl) toluene, bis(p-amino-t-butylphenyl)ether, bis(p-methyl-o-aminophenyl)benzene, bis(p-methyl-o-aminopentyl)benzene, 1,3-diamino-4-isopropylbenzene, bis(4-aminophenyl) sulfide, bis(4-aminophenyl) sulfone, bis(4-aminophenyl)ether, 1,3-bis(3-aminopropyl)tetramethyldisiloxane, and mixtures thereof. In some embodiments, the diamine is an aromatic diamine, more specifically, m-phenylenediamine, p-phenylenediamine, sulfonyl dianiline, or a mixture thereof.

In general, polyimide-forming reactions can be carried out employing various solvents, e.g., o-dichlorobenzene, m-cresol/toluene, and the like, to effect a reaction between the dianhydride and the diamine, at temperatures of 100° C. to 250° C. Alternatively, the polyimide block can be prepared by melt polymerization or interfacial polymerization, e.g., melt polymerization of an aromatic bis(anhydride) and a diamine by heating a mixture of the starting materials to elevated temperatures with concurrent stirring. Generally, melt polymerizations employ temperatures of 200° C. to 400° C. A chain-terminating agent can be employed to control the molecular weight of the polyimide. Monofunctional amines such as aniline, or monofunctional anhydrides such as phthalic anhydride can be employed. Polyimides are commercially available from companies including SABIC Innovative Plastics LLC.

The particulate engineering plastic can be a poly(phenylene sulfide). Poly(phenylene sulfides) comprise repeating units of the formula

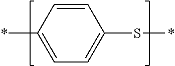

and can be formed by reaction of 1,4-dichlorophenol with sodium sulfide. Poly(phenylene sulfides) comprise repeating units of the formulae

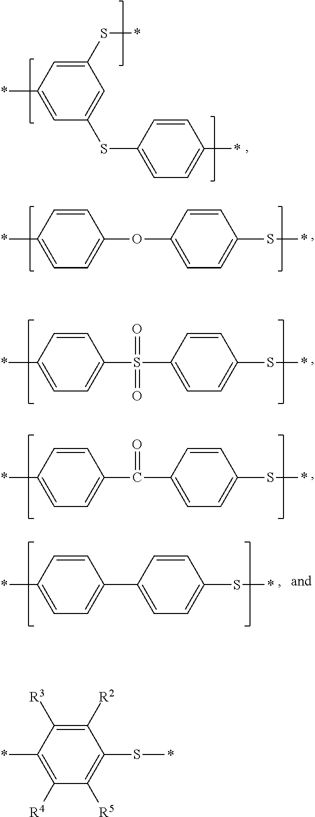

wherein R², R³, R⁴ and R⁵ are, independently at each occurrence, hydrogen, halogen, C₁-C₁₂ hydrocarbyl, C₁-C₁₂ hydrocarbyloxy, nitro, amino, or carboxy. As used herein, the term “hydrocarbyl”, whether used by itself, or as a prefix, suffix, or fragment of another term, refers to a residue that contains only carbon and hydrogen unless it is specifically identified as “substituted hydrocarbyl”. The hydrocarbyl residue can be aliphatic or aromatic, straight-chain, cyclic, bicyclic, branched, saturated, or unsaturated. It can also contain combinations of aliphatic, aromatic, straight chain, cyclic, bicyclic, branched, saturated, and unsaturated hydrocarbon moieties. When the hydrocarbyl residue is described as substituted, it can contain heteroatoms in addition to carbon and hydrogen. Poly(phenylene sulfide)s are commercially available from companies including Chevron Phillips Chemical Company (as RYTON™ PPS) and Ticona Engineering Polymers (as FORTRON™ PPS).

The particulate engineering plastic can be a semi-crystalline polyamide. Polyamides, commonly called nylons, are produced by the condensation polymerization of dicarboxylic acids and diamines or the catalytic polymerization of a lactam monomer (a cyclic amide). In general, polyamides are semicrystalline thermoplastics. Polyamides are a class of resins characterized by broad chemical resistance, high strength and toughness. The family of polyamides includes aliphatic, semi-aromatic, and aromatic polyamides. Aliphatic polyamides include polyamide-6,6 (nylon 6,6) and polyamide-4,6 (nylon 4,6). Polyamide-6,6 can be formed from the condensation of a six-carbon diamine (hexamethylene diamine) and a six-carbon dibasic acid (adipic acid). It has a crystalline melting point (Tₘ) around 269° C. Polyamide-4,6 can be prepared by the condensation of a four-carbon diamine and adipic acid. Nylon 4,6 has a Tₘ of 295° C.

Semi-aromatic polyamides are typically based on modified copolymers of poly(hexamethylene terephthalate), also known as polyamide-6,T and nylon 6,T. Semi-aromatic polyamides are of interest because of their enhanced properties over aliphatic polyamides. Pure polyamide-6,T exhibits a very high crystalline melting point, Tₘ, of 370° C. and a glass transition temperature, T_{g}, of 180° C. The high Tₘ can result in expensive polymerization processes and difficulty in molding. Hence, terpolymers using an inexpensive third monomer such as isophthalic acid, adipic acid, caprolactam, or 1,5-hexyanediamine are often used in commercial semi-aromatic polyamides. These terpolymers exhibit Tₘ values from 290 to 320° C. and T_{g} values of 100 to 125° C. Semi-aromatic polyamides are commercially available from Amoco (as AMODEL™ R Resin), BASF (as ULTRAMID™ T Resin), and duPont (as ZYTEL™ HTN Resin).

Aromatic polyamides include, for example, poly(p-phenylene terephthalamide), which is commercially available from DuPont as KEVLAR™ Resin.

In some embodiments, the semi-crystalline polyamide comprises polyamide-6; polyamide-4,6; polyamide-6,6; a terpolymer of 1,6-hexanediamine and terephthalic acid and a third monomer comprising isophthalic acid, adipic acid, caprolactam, 1,5-hexanediamine, or a combination of the foregoing third monomers; or a combination of the foregoing semi-crystalline polyamides.

The particulate engineering plastic has a mean particle size of 5 to 1000 micrometers. Within this range, the mean particle size can be 5 to 600 micrometers, specifically 5 to 400 micrometers, more specifically 5 to 200 micrometers. In some embodiments, 90 percent of the particle volume distribution of the particulate poly(phenylene ether) is less than or equal to 1500 micrometers, specifically less than or equal to 500 micrometers, more specifically 5 to 500 micrometers. In some embodiments, fifty percent of the particle volume distribution of the particulate poly(phenylene ether) is than or equal to 500 micrometers, specifically less than or equal to 300 micrometers, more specifically less than or equal to 200 micrometers. In some embodiments, ten percent of the particle volume distribution of the particulate poly(phenylene ether) is less than or equal to 200 micrometers, specifically less than or equal to 100 micrometers, more specifically less than or equal to 50 micrometers. In some embodiments, the particles of the particulate engineering plastic have a mean aspect ratio of 1:1 to 2:1. Equipment to determine particle size and shape characteristics is commercially available as, for example, the CAMSIZER™ and CAMSIZER™ XT Dynamic Image Analysis Systems from Retsch Technology, and the QICPIC™ Particle Size and Shape Analyzer from Sympatec.

Particulate engineering plastics can be obtained according to methods readily available to the skilled artisan, for example by jet milling, ball milling, pulverizing, air milling, or grinding commercial grade engineering plastics. “Classification” is defined as the sorting of a distribution of particles to achieve a desired degree of particle size uniformity. A classifier is often used together with milling for the continuous extraction of fine particles from the material being milled. The classifier can be, for example, a screen of certain mesh size on the walls of the grinding chamber. Once the milled particles reach sizes small enough to pass through the screen, they are removed. Larger particles retained by the screen remain in the milling chamber for additional milling and size reduction.

Air classification is another method of removing the finer particles from milling. Air classifiers include static classifiers (cyclones), dynamic classifiers (single-stage, multi-stage), cross-flow classifiers, and counter-flow classifiers (elutriators). In general, a flow of air is used to convey the particles from the mill to the classifier, where the fine particles are further conveyed to a collector. The coarse particles, being too heavy to be carried by the air stream, are returned to the mill for further milling and size reduction. In larger operations, air classification is more efficient, while in smaller operations a screen can be used.

The composition comprises the particulate engineering plastic in an amount of 5 to 50 weight percent, based on the total weight of the composition. Within this range, the amount of particulate engineering plastic can be 5 to 40 weight percent, specifically 10 to 30 weight percent.

The composition can be prepared by blending the particulate engineering thermoplastic into the thermoplastic polyurethane at temperatures below the glass transition temperature or crystalline melting point of the engineering thermoplastic. This method avoids softening of the engineering thermoplastic and any agglomeration of the softened engineering thermoplastic and results in a dispersion of ultrafine particles of engineering thermoplastic in the thermoplastic polyurethane matrix. Moreover, compounding engineering thermoplastics into thermoplastic polyurethane via melt mixing the two polymers would be difficult because the required processing temperatures for the engineering thermoplastic would be above the decomposition temperature of the thermoplastic polyurethane.

Alternatively, the composition can be prepared by the polyurethane in the presence of the particulate engineering thermoplastic. In this method, the particulate engineering thermoplastic can be slurried in the polymeric diol component, the diisocyanate, or both, prior to the polyurethane-forming reaction.

In a very specific embodiment of the composition, the composition comprises the polyarylsulfone; wherein the polyarylsulfone comprises poly(1,4-phenylene ether-ether-sulfone) (CAS Reg. No. 28212-68-2); the particulate engineering plastic has a mean particle size of 5 to 600 micrometers; the thermoplastic polyurethane is the reaction product of reactants comprising a polymeric diol comprising a polyether diol, a polyester diol, or a combination thereof, and a diisocyanate comprising 2,4′-diphenylmethane diisocyanate, 4,4′-diphenylmethane diisocyanate, toluene 2,6-diisocyanate, toluene 2,4-diisocyanate, or a combination thereof; and the composition comprises 70 to 90 weight percent of the thermoplastic polyurethane, and 10 to 30 weight percent of the particulate engineering plastic.

The composition is useful for molding articles, including films, sheets, cable sheathing, spiral tubing, pneumatic tubing, blow molded bellows, ski boot shells, sport shoe soles, caster tires, belts for machinery, heat sealed textile lamination, automotive body panels, and automotive rocker panels. Suitable methods of forming such articles include single layer and multilayer sheet extrusion, injection molding, blow molding, film extrusion, profile extrusion, pultrusion, compression molding, thermoforming, pressure forming, hydroforming, vacuum forming, and the like. Combinations of the foregoing article fabrication methods can be used.

One embodiment is an article comprising a composition comprising: 50 to 95 weight percent of a thermoplastic polyurethane; and 5 to 50 weight percent of a particulate engineering plastic; wherein the particulate engineering plastic comprises a polyarylsulfone, a polyimide, a poly(phenylene sulfide), a semi-crystalline polyamide, or a combination thereof; wherein the particulate engineering plastic has a glass transition temperature or a crystalline melting point greater than or equal to 200° C.; wherein the particulate engineering plastic has a mean particle size of 5 to 1000 micrometers; and wherein the weight percent values are based on the total weight of the composition.

In a very specific embodiment of the article, the composition comprises the polyarylsulfone; wherein the polyarylsulfone comprises poly(1,4-phenylene ether-ether-sulfone) (CAS Reg. No. 28212-68-2); the particulate engineering plastic has a mean particle size of 5 to 600 micrometers; the thermoplastic polyurethane is the reaction product of reactants comprising a polymeric diol comprising a polyether diol, a polyester diol, or a combination thereof, and a diisocyanate comprising 2,4′-diphenylmethane diisocyanate, 4,4′-diphenylmethane diisocyanate, toluene 2,6-diisocyanate, toluene 2,4-diisocyanate, or a combination thereof; and the composition comprises 70 to 90 weight percent of the thermoplastic polyurethane, and 10 to 30 weight percent of the particulate engineering plastic.

All ranges disclosed herein are inclusive of the endpoints, and the endpoints are independently combinable with each other. Each range disclosed herein constitutes a disclosure of any point or sub-range lying within the disclosed range.

The invention includes at least the following embodiments.

### Embodiment 1

A composition comprising: 50 to 95 weight percent of a thermoplastic polyurethane; and 5 to 50 weight percent of a particulate engineering plastic; wherein the particulate engineering plastic comprises a polyarylsulfone, a polyimide, a poly(phenylene sulfide), a semi-crystalline polyamide, or a combination thereof; wherein the particulate engineering plastic has a glass transition temperature or a crystalline melting point greater than or equal to 200° C.; wherein the particulate engineering plastic has a mean particle size of 5 to 1000 micrometers; and wherein the weight percent values are based on the total weight of the composition.

### Embodiment 2

The composition of embodiment 1, wherein the particulate engineering plastic comprises a polyarylsulfone.

### Embodiment 3

The composition of embodiment 2, wherein the polyarylsulfone comprises poly(oxy-1,4-phenylenesulfonyl-1,4-phenylene) (CAS Reg. No. 25667-42-9), poly(1,4-phenylene ether-ether-sulfone) (CAS Reg. No. 28212-68-2), a copolymer of 1,1′-biphenyl-4,4′-diol and 1,1-sulfonyl-bis(4-chlorobenzene) (copolymer CAS Reg. No. 25608-64-4), or a combination thereof.

### Embodiment 4

The composition of any of embodiments 1-3, wherein the particulate engineering plastic comprises a polyimide.

### Embodiment 5

The composition of embodiment 4, wherein the polyimide is a polyetherimide comprising poly[2,2-bis(4-(3,4-dicarboxyphenoxy)phenyl)propane-1,3-phenylene bisimide] (CAS Reg. No. 61128-46-9).

### Embodiment 6

The composition of any of embodiments 1-5, wherein the particulate engineering plastic comprises a poly(phenylene sulfide).

### Embodiment 7

The composition of any of embodiments 1-6, wherein the particulate engineering plastic comprises a semi-crystalline polyamide.

### Embodiment 8

The composition of embodiment 7, wherein the semi-crystalline polyamide comprises polyamide-6; polyamide-4,6; polyamide-6,6; a terpolymer of 1,6-hexanediamine and terephthalic acid and a third monomer comprising isophthalic acid, adipic acid, caprolactam, 1,5-hexanediamine, or a combination of the foregoing third monomers; or a combination of the foregoing semi-crystalline polyamides.

### Embodiment 9

The composition of any of embodiments 1-8, wherein the particulate engineering plastic has a mean particle size of 5 to 600 micrometers.

### Embodiment 10

The composition of any of embodiments 1-9, wherein the glass transition temperature or crystalline melting point is 250 to 350° C.

### Embodiment 11

The composition of any of embodiments 1-10, comprising 10 to 30 weight percent of the particulate engineering plastic.

### Embodiment 12

The composition of any of embodiments 1-11, wherein the thermoplastic polyurethane is the reaction product of reactants comprising a polymeric diol and a diisocyanate.

### Embodiment 13

The composition of embodiment 12, wherein the polymeric diol comprises a polyether diol.

### Embodiment 14

The composition of embodiment 12 or 13, wherein the polymeric diol comprises a polyester diol.

### Embodiment 15

The composition of any of embodiments 12-14, wherein the diisocyanate comprises 2,4′-diphenylmethane diisocyanate, 4,4′-diphenylmethane diisocyanate, toluene 2,6-diisocyanate, toluene 2,4-diisocyanate, or a combination thereof.

### Embodiment 16

The composition of embodiment 1, wherein the composition comprises the polyarylsulfone; wherein the polyarylsulfone comprises poly(1,4-phenylene ether-ether-sulfone) (CAS Reg. No. 28212-68-2); wherein the particulate engineering plastic has a mean particle size of 5 to 600 micrometers; wherein the thermoplastic polyurethane is the reaction product of reactants comprising a polymeric diol comprising a polyether diol, a polyester diol, or a combination thereof, and a diisocyanate comprising 2,4′-diphenylmethane diisocyanate, 4,4′-diphenylmethane diisocyanate, toluene 2,6-diisocyanate, toluene 2,4-diisocyanate, or a combination thereof; and wherein the composition comprises 70 to 90 weight percent of the thermoplastic polyurethane; and 10 to 30 weight percent of the particulate engineering plastic.

### Embodiment 17

An article comprising a composition comprising: 50 to 95 weight percent of a thermoplastic polyurethane; and 5 to 50 weight percent of a particulate engineering plastic; wherein the particulate engineering plastic comprises a polyarylsulfone, a polyimide, a poly(phenylene sulfide), a semi-crystalline polyamide, or a combination thereof; wherein the particulate engineering plastic has a glass transition temperature or a crystalline melting point greater than or equal to 200° C.; wherein the particulate engineering plastic has a mean particle size of 5 to 1000 micrometers; and wherein the weight percent values are based on the total weight of the composition.

### Embodiment 18

The article of embodiment 17, selected from the group consisting of films, sheets, cable sheathing, spiral tubing, pneumatic tubing, blow molded bellows, ski boot shells, sport shoe soles, caster tires, belts for machinery, heat sealed textile lamination, automotive body panels, and automotive rocker panels.

### Embodiment 19

The article of embodiment 17 or 18, wherein the composition comprises the polyarylsulfone; wherein the polyarylsulfone comprises poly(1,4-phenylene ether-ether-sulfone) (CAS Reg. No. 28212-68-2); wherein the particulate engineering plastic has a mean particle size of 5 to 600 micrometers; wherein the thermoplastic polyurethane is the reaction product of reactants comprising a polymeric diol comprising a polyether diol, a polyester diol, or a combination thereof, and a diisocyanate comprising 2,4′-diphenylmethane diisocyanate, 4,4′-diphenylmethane diisocyanate, toluene 2,6-diisocyanate, toluene 2,4-diisocyanate, or a combination thereof; and wherein the composition comprises 70 to 90 weight percent of the thermoplastic polyurethane; and 10 to 30 weight percent of the particulate engineering plastic.

The invention is further illustrated by the following non-limiting examples.

### Examples 1-11, Comparative Examples 1 and 2

Blends of particulate engineering thermoplastics with particulate thermoplastic polyurethanes were prepared by extrusion below the glass transition temperature or crystalline melting point of the engineering thermoplastics. Test parts of blended ultrafine particles of engineering thermoplastics and TPUs were prepared by injection molding below the glass transition temperature or crystalline melting point of the engineering thermoplastics. Materials used in these experiments are summarized in Table 1.

TABLE 1

| Component | Description |
|---|---|
| TPU-1 | Polyether-based thermoplastic polyurethane; obtained from BASF as |
| | ELASTOLLAN ™ 1185; cryogenically ground to a powder before use. |
| TPU-2 | Polyester-based thermoplastic polyurethane; obtained from BASF as |
| | ELASTOLLAN ™ C85; cryogenically ground to a powder before use. |
| PES | Polyether sulfone (poly(1,4-phenylene ether-ether-sulfone), CAS Reg. No. |
| | 28212-68-2; obtained in pellet form as catalog number 440965 from |
| | Sigma-Aldrich Co. LLC; cryogenically ground to a powder before use. |
| PEI | Poly[2,2-bis(4-(3,4-dicarboxyphenoxy)phenyl)propane-1,3-phenylene |
| | bisimide], CAS Reg. No. 61128-46-9; obtained in pellet form as ULTEM ™ |
| | 1010 Resin from SABIC Innovative Plastics LLC; ground to a powder before |
| | use. |
| PPS | Poly(1,4-phenylene sulfide) having a number average molecular weight of |
| | about 10,000 atomic mass units; obtained in powder form as catalog number |
| | 182354 from Sigma-Aldrich Co. LLC. |
| PA66 | Polyamide-6,6; obtained in pellet form as TORZEN ™ U4500 NC01 from |
| | Invista Engineering Polymers; cryogenically ground to a powder before use. |

Table 2 summarizes particle size characterization of the particulate engineering resins. The particle size and shape characterizations in Table 2 were determined using a CAMSIZER™ XT from Retsch Technology GmbH operating in air dispersion mode. In Table 2, the Particle Formation “Milling” refers to jet milling as provided by ICO Polymers; “Cryogenic Milling” refers to using a Pallmann Turbo Mill Model PPL18 (manufactured by Pallmann Maschinenfabrik GmbH) operating at 5000 rotations per minute (rpm). The bottom of a small metal pan was covered with the thermoplastic pellets (approximately 5-7 millimeters in depth). Liquid nitrogen was poured over the pellets so that they were completely covered. After 30 to 60 seconds, the pellet-liquid nitrogen mixture was slowly poured onto the vibrating tray feeding the Turbo Mill. The pulverized material was allowed to warm to room temperature and then sieved using a Number 10 sieve (2.0 millimeter openings) to remove the larger particles. Then the material was dried in a vacuum oven at 125° C. for 4 hours at 600 millimeters mercury vacuum.

Also in Table 2, “Mean Particle Size (μm)” is the mean particle size on a volume basis, expressed in units of micrometers; “Particle Size Std. Dev. (μm)” is the standard deviation of the particle size on a volume basis, expressed in units of micrometers; “D(v,0.5)(μm)” is particle size, in micrometers, for which 50% of the volume distribution is below the stated value; “D(v,0.9)(μm)” is particle size, in micrometers, for which 90% of the volume distribution is below the stated value; and “Aspect Ratio” is the mean ratio of the longest dimension to the shortest dimension on a particle basis.

TABLE 2

| | | | Particle | | | | |
|---|---|---|---|---|---|---|---|
| | | Mean | Size | | | | |
| | | Particle | Std. | | | | |
| | Particle Formation | Size | Dev. | D(v, 0.9) | D(v, 0.5) | D(v, 0.1) | Aspect |
| Resin | Method | (μm) | (μm) | (μm) | (μm) | (μm) | Ratio |
| PES | Cryogenic Milling | 596.6 | 507.7 | 1298.1 | 435.2 | 164.2 | 1.653:1 |
| PEI | Milling | 473.9 | 448.7 | 1248.6 | 288.6 | 102.6 | 1.689:1 |
| PPS | Powder from | 37.6 | 29.6 | 72.4 | 30.7 | 9.3 | 1.305:1 |
| | supplier | | | | | | |
| PA66 | Cryogenic Milling | 107.3 | 53.9 | 182.2 | 103.6 | 41.2 | 1.495:1 |

Tables 3 and 4 present compounding conditions for polyether-based TPU-1 and polyester-based TPU-2, respectively. Compositions were compounded on a Coperion ZSK 18 twin-screw laboratory with an 18 millimeter screw outer diameter.

TABLE 3

| | | | | | | | | Screw |
|---|---|---|---|---|---|---|---|---|
| | Zone 1 | Zone 2 | Zone 3 | Zone 4 | Zone 5 | Zone 6 | Die | Rot. |
| | Temp. | Temp. | Temp. | Temp. | Temp. | Temp. | Temp. | Rate |
| | (° C.) | (° C.) | (° C.) | (° C.) | (° C.) | (° C.) | (° C.) | (rpm) |
| Ex. 1 | 150 | 160 | 170 | 180 | 180 | 190 | 190 | 300 |
| Ex. 2 | 150 | 160 | 170 | 180 | 180 | 180 | 190 | 350 |
| Ex. 3 | 150 | 160 | 170 | 180 | 180 | 190 | 190 | 300 |
| Ex. 4 | 180 | 190 | 200 | 200 | 200 | 200 | 200 | 300 |
| Ex. 5 | 180 | 190 | 200 | 200 | 200 | 200 | 200 | 400 |
| Ex. 6 | 180 | 190 | 200 | 210 | 210 | 210 | 210 | 400 |
| Ex. 7 | 150 | 160 | 170 | 180 | 180 | 180 | 190 | 350 |
| Ex. 8 | 150 | 160 | 170 | 180 | 180 | 190 | 190 | 300 |

TABLE 4

| | | | | | | | | Screw |
|---|---|---|---|---|---|---|---|---|
| | Zone 1 | Zone 2 | Zone 3 | Zone 4 | Zone 5 | Zone 6 | Die | Rot. |
| | Temp. | Temp. | Temp. | Temp. | Temp. | Temp. | Temp. | Rate |
| | (° C.) | (° C.) | (° C.) | (° C.) | (° C.) | (° C.) | (° C.) | (rpm) |
| Ex. 9 | 150 | 160 | 170 | 180 | 180 | 190 | 190 | 300 |
| Ex. 10 | 150 | 160 | 170 | 180 | 180 | 180 | 190 | 350 |
| Ex. 11 | 180 | 190 | 200 | 210 | 210 | 210 | 210 | 400 |

Tables 5 and 6 present injection molding conditions for polyether-based TPU-1 and polyester-based TPU-2, respectively. Molding was conducted on a Demag Plastic Group Model 40-80 injection molding machine.

TABLE 5

| | | | | | | Injec- | Back |
|---|---|---|---|---|---|---|---|
| | Zone 1 | Zone 2 | Zone 3 | Nozzle | Mold | tion | Pres- |
| | Temp. | Temp. | Temp. | Temp. | Temp. | Pressure | sure |
| | (° C.) | (° C.) | (° C.) | (° C.) | (° C.) | (kPa) | (kPa) |
| C. Ex. 1 | 199 | 199 | 199 | 205 | 27 | 12,400 | 340 |
| Ex. 1 | 218 | 218 | 218 | 218 | 38 | 10,300 | 140 |
| Ex. 2 | 221 | 221 | 221 | 221 | 38 | 10,300 | 140 |
| Ex. 3 | 221 | 221 | 221 | 221 | 38 | 10,300 | 140 |
| Ex. 4 | 204 | 204 | 204 | 204 | 16 | 14,500 | 140 |
| Ex. 5 | 210 | 210 | 210 | 210 | 16 | 11,000 | 140 |
| Ex. 6 | 210 | 210 | 210 | 210 | 16 | 11,000 | 140 |
| Ex. 7 | 193 | 193 | 193 | 193 | 38 | 8,300 | 140 |
| Ex. 8 | 221 | 221 | 221 | 210 | 27 | 6,900 | 140 |

TABLE 6

| | | | | | | Injec- | Back |
|---|---|---|---|---|---|---|---|
| | Zone 1 | Zone 2 | Zone 3 | Nozzle | Mold | tion | Pres- |
| | Temp. | Temp. | Temp. | Temp. | Temp. | Pressure | sure |
| | (° C.) | (° C.) | (° C.) | (° C.) | (° C.) | (kPa) | (kPa) |
| C. Ex. 2 | 199 | 199 | 199 | 205 | 27 | 14,500 | 340 |
| Ex. 9 | 221 | 221 | 221 | 221 | 38 | 11,000 | 140 |
| Ex. 10 | 193 | 193 | 193 | 193 | 38 | 9,700 | 140 |
| Ex. 11 | 210 | 210 | 210 | 210 | 16 | 12,400 | 140 |

Tables 7 and 8 present compositions and properties for polyether-based TPU-1 and polyester-based TPU-2, respectively. For the compositions, component amounts are expressed in weight percent based on the total weight of the composition. Density values, expressed in grams/centimeter³, were determined at 23° C. according to ASTM D792-08. Shore A and Shore D hardness values, which are unitless, were determined at 23° C. according to ASTM D 2240-05 (2010). Values of modulus of elasticity (expressed in units of megapascals), tensile stress at yield (expressed in units of megapascals), tensile stress at break (expressed in units of megapascals), tensile elongation at yield (expressed in units of percent), and tensile elongation at break (expressed in units of percent) were determined at 23° C. according to ASTM D 412-06a (2013), Test Method A, using an Instron Universal Tester, Model 1122 and a test speed of 50.8 centimeters/minute (20 inches/minute). Vicat softening temperature values, expressed in units of degrees centigrade, were determined according to ASTM D 1525-09. Char values in nitrogen and air, expressed in units of weight percent, were determined using a TGA Perkin Elmer Pyris 1. The samples were heated from 50 to 800° C. at 20 degrees per minute in air and nitrogen. The residue at 600, 700, and 800° C. was the percent char.

The Table 7 and 8 data show that there was an enhancement of properties with the use of particulate engineering plastic in thermoplastic polyurethane. For particulate PES-containing Examples 1-3 relative to the control, Comparative Example 1, tensile strength objective metrics tensile stress at yield and break increased with increasing PES content at all levels while maintaining high elongations at yield and break. The heat resistance objective metric VICAT A also increased with increasing PES content at all levels. Hardness, objectively determined as Shore A and Shore D hardness, also increased with increasing PES content at all levels. And char formation increased with increasing PES content at all levels under all temperature and atmosphere combinations.

For particulate PEI-containing Examples 4-6 relative to the control, Comparative Example 1, tensile stress values at yield and break increased at 20% PEI while maintaining high elongations at yield and break (stress values at yield and break were also increased at 30% PEI, but elongations were compromised). VICAT A increased with increasing PEI content at all levels. Shore A and Shore D hardness increased with increasing PEI content at all levels, with the exception of the Shore D hardness at 20% PEI, which was slightly lower than the value at 10% PEI but still higher than that of the control. And char formation increased with increasing PEI content at all levels under all temperature and atmosphere combinations.

For 20% particulate PPS-containing Example 7 relative to the control, Comparative Example 1, increases were exhibited for VICAT A, Shore A and Shore D hardnesses, and char values under all conditions tested.

For 20% particulate PA66-containing Example 8 relative to the control, Comparative Example 1, increases were exhibited for Shore A hardness, and char values under all conditions tested except 600 and 700° C. in air.

Increased char suggests less fuel is being produced from thermal decomposition. This could facilitate flame retarding of the particulate engineering plastic-containing compositions. For example, the presence of particulate engineering plastic may allow the use of less flame retardant additive to reach a comparable level of flame retardancy.

TABLE 7

| | | | | |
|---|---|---|---|---|
| C. Ex. 1 | Ex. 1 | Ex. 2 | Ex. 3 | Ex. 4 |

COMPOSITIONS

| | | | | | |
|---|---|---|---|---|---|
| TPU-1 | 100 | 90 | 80 | 70 | 90 |
| PES | 0 | 10 | 20 | 30 | 0 |
| PEI | 0 | 0 | 0 | 0 | 10 |
| PPS | 0 | 0 | 0 | 0 | 0 |
| PA66 | 0 | 0 | 0 | 0 | 0 |

PROPERTIES

| | | | | | |
|---|---|---|---|---|---|
| Density (g/cc) | 1.1169 | 1.1387 | 1.1589 | 1.1786 | 1.1337 |
| Hardness-Shore A | 87.8 | 91.2 | 93.1 | 95.2 | 89.9 |
| Hardness-Shore D | 39.2 | 41.8 | 44.8 | 47.0 | 42.0 |
| Modulus of Elasticity (MPa) | 638.07 | 622.5 | 612.4 | 603.2 | 623.03 |
| Tensile Stress at Yield (MPa) | 11.7 | 16.1 | 20.4 | 23.1 | 11.1 |
| Tensile Stress at Break (MPa) | 10.7 | 16.4 | 20.6 | 23.1 | 11.1 |
| Tensile Elongation at Yield (%) | 620 | 609 | 604 | 603 | 604 |
| Tensile Elongation at Break (%) | 625 | 610 | 605 | 603 | 605 |
| VICAT A (° C.) | 96.8 | 103.4 | 108.9 | 115.9 | 98.1 |
| Char in N₂ at 600° C. (wt %) | 3.6 | 6.26 | 13.39 | 18.76 | 8.21 |
| Char in N₂ at 700° C. (wt %) | 3.3 | 5.71 | 11.42 | 16.75 | 7.55 |
| Char in N₂ at 800° C. (wt %) | 3.1 | 4.82 | 10.04 | 15.18 | 7.26 |
| Char in air at 600° C. (wt %) | 14.3 | 17.13 | 23.64 | 29.28 | 18.65 |
| Char in air at 700° C. (wt %) | 5.7 | 10.22 | 17.37 | 22.34 | 12.55 |
| Char in air at 800° C. (wt %) | 0.2 | 2.94 | 8.77 | 12.75 | 4.28 |

| | | | |
|---|---|---|---|
| Ex. 5 | Ex. 6 | Ex. 7 | Ex. 8 |

COMPOSITIONS

| | | | | |
|---|---|---|---|---|
| TPU-1 | 80 | 70 | 70 | 70 |
| PES | 0 | 0 | 0 | 0 |
| PEI | 20 | 30 | 0 | 0 |
| PPS | 0 | 0 | 30 | 0 |
| PA66 | 0 | 0 | 0 | 30 |

PROPERTIES

| | | | | |
|---|---|---|---|---|
| Density (g/cc) | 1.1506 | 1.1659 | 1.1858 | 1.1211 |
| Hardness-Shore A | 92.4 | 94.2 | 93.8 | 93.3 |
| Hardness-Shore D | 41.5 | 45.6 | 40.5 | 39.0 |
| Modulus of Elasticity (MPa) | 602.52 | 346.35 | 600.42 | 629.81 |
| Tensile Stress at Yield (MPa) | 13.2 | 12.5 | 8.4 | 11.4 |
| Tensile Stress at Break (MPa) | 13.2 | 12.1 | 9.8 | 11.4 |
| Tensile Elongation at Yield (%) | 605 | 284 | 196 | 616 |
| Tensile Elongation at Break (%) | 605 | 316 | 572 | 617 |
| VICAT A (° C.) | 102.9 | 110.1 | 97.6 | 78.5 |
| Char in N₂ at 600° C. (wt %) | 16.72 | 23.66 | 18.99 | 7.72 |
| Char in N₂ at 700° C. (wt %) | 14.87 | 20.51 | 17.55 | 7.40 |
| Char in N₂ at 800° C. (wt %) | 14.28 | 19.59 | 17.02 | 7.18 |
| Char in air at 600° C. (wt %) | 27.48 | 34.58 | 21.95 | 12.49 |
| Char in air at 700° C. (wt %) | 21.16 | 26.75 | 16.75 | 5.15 |
| Char in air at 800° C. (wt %) | 11.7 | 15.92 | 7.23 | 0.265 |

TABLE 8

| | | | |
|---|---|---|---|
| C. Ex. B | Ex. 9 | Ex. 10 | Ex. 11 |

COMPOSITIONS

| | | | | |
|---|---|---|---|---|
| TPU-2 | 100 | 70 | 70 | 70 |
| PES | 0 | 30 | 0 | 0 |
| PEI | 0 | 0 | 30 | 0 |
| PPS | 0 | 0 | 0 | 30 |

PROPERTIES

| | | | | |
|---|---|---|---|---|
| Density (g/cc) | 1.185 | 1.2246 | 1.2109 | 1.2328 |
| Hardness-Shore A | 87.9 | 94.9 | 93.9 | 93.5 |
| Hardness-Shore D | 38.5 | 44.8 | 43.3 | 38.4 |
| Modulus of Elasticity | 653.6 | 609.4 | 350.2 | 607.6 |
| (MPa) | | | | |
| Tensile Stress at Yield | 9.5 | 19.9 | 11.9 | 8.4 |
| (MPa) | | | | |
| Tensile Stress at Break | 9.1 | 20.9 | 12.6 | 10.3 |
| (MPa) | | | | |
| Elongation at Yield (%) | 637 | 515 | 263 | 185 |
| Elongation at Break (%) | 637 | 520 | 297 | 552 |
| VICAT A (° C.) | 105 | 118.4 | 115.3 | 107.6 |

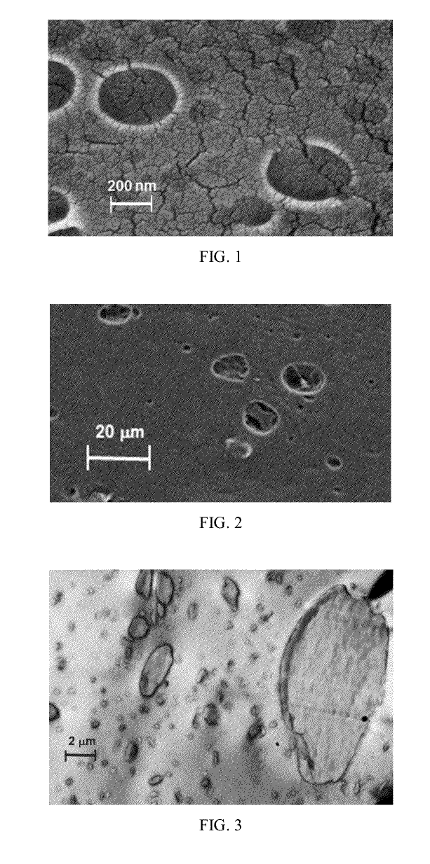

Scanning Electronic Microscopy (SEM) was used to assess the dispersion of particles of polyethersulfone and polyetherimide. The microtomed surfaces of Example 3 and Example 6 molded articles were etched in chloroform for 15 seconds. The polyethersulfone and polyetherimide are soluble in chloroform and thus expected to be removed from the surface. Hence the voids give a representation of the polyethersulfone and polyetherimides dispersion and domain size. The samples were examined using a Carl Zeiss AG-EVO® 40 Series scanning electron microscope. The conditions were SEM mode, a probe current of 40 picoamps, HV (high vacuum), and an acceleration voltage of 20 kilovolts. The images Example 3 and Example 6 were obtained at magnifications of 40,000× and 300×, respectively. The images appear in FIGS. 1 and 2, and they indicate that the thermoplastic particles are being ground to a smaller particle size in the extruder.

The dispersion of particles of poly(phenylene sulfide) was investigated by scanning transmission electron microscopy. The microtomed surface of the Example 7 molded article was stained with osmium tetroxide and ruthenium tetroxide and observed with a Zeiss EVO40 XVP scanning electron microscope with scanning transmission electron microscopy module. A representative micrograph was obtained at the magnification of 5000× and appears in FIG. 3. The micrograph indicates that the poly(phenylene sulfide) particles are being ground to a smaller particle size in the extruder.

1. A composition comprising:
50 to 95 weight percent of a thermoplastic polyurethane; and
5 to 50 weight percent of a particulate engineering plastic;
wherein the particulate engineering plastic comprises a polyarylsulfone, a polyimide, a poly(phenylene sulfide), a semi-crystalline polyamide, or a combination thereof;
wherein the particulate engineering plastic has a glass transition temperature or a crystalline melting point greater than or equal to 200° C.;
wherein the particulate engineering plastic has a mean particle size of 5 to 1000 micrometers; and
wherein the weight percent values are based on the total weight of the composition.

2. The composition of claim 1, wherein the particulate engineering plastic comprises a polyarylsulfone.

3. The composition of claim 2, wherein the polyarylsulfone comprises poly(oxy-1,4-phenylenesulfonyl-1,4-phenylene) (CAS Reg. No. 25667-42-9), poly(1,4-phenylene ether-ether-sulfone) (CAS Reg. No. 28212-68-2), a copolymer of 1,1′-biphenyl-4,4′-diol and 1,1-sulfonyl-bis(4-chlorobenzene) (copolymer CAS Reg. No. 25608-64-4), or a combination thereof.

4. The composition of claim 1, wherein the particulate engineering plastic comprises a polyimide.

5. The composition of claim 4, wherein the polyimide is a polyetherimide comprising poly[2,2-bis(4-(3,4-dicarboxyphenoxy)phenyl)propane-1,3-phenylene bisimide] (CAS Reg. No. 61128-46-9).

6. The composition of claim 1, wherein the particulate engineering plastic comprises a poly(phenylene sulfide).

7. The composition of claim 1, wherein the particulate engineering plastic comprises a semi-crystalline polyamide.

8. The composition of claim 7, wherein the semi-crystalline polyamide comprises polyamide-6; polyamide-4,6; polyamide-6,6; a terpolymer of 1,6-hexanediamine and terephthalic acid and a third monomer comprising isophthalic acid, adipic acid, caprolactam, 1,5-hexanediamine, or a combination of the foregoing third monomers; or a combination of the foregoing semi-crystalline polyamides.

9. The composition of claim 1, wherein the particulate engineering plastic has a mean particle size of 5 to 600 micrometers.

10. The composition of claim 1, wherein the glass transition temperature or crystalline melting point is 250 to 350° C.

11. The composition of claim 1, comprising 10 to 30 weight percent of the particulate engineering plastic.

12. The composition of claim 1, wherein the thermoplastic polyurethane is the reaction product of reactants comprising a polymeric diol and a diisocyanate.

13. The composition of claim 12, wherein the polymeric diol comprises a polyether diol.

14. The composition of claim 12, wherein the polymeric diol comprises a polyester diol.

15. The composition of claim 12, wherein the diisocyanate comprises 2,4′-diphenylmethane diisocyanate, 4,4′-diphenylmethane diisocyanate, toluene 2,6-diisocyanate, toluene 2,4-diisocyanate, or a combination thereof.

16. The composition of claim 1,
wherein the composition comprises the polyarylsulfone; wherein the polyarylsulfone comprises poly(1,4-phenylene ether-ether-sulfone) (CAS Reg. No. 28212-68-2);
wherein the particulate engineering plastic has a mean particle size of 5 to 600 micrometers;
wherein the thermoplastic polyurethane is the reaction product of reactants comprising
a polymeric diol comprising a polyether diol, a polyester diol, or a combination thereof, and
a diisocyanate comprising 2,4′-diphenylmethane diisocyanate, 4,4′-diphenylmethane diisocyanate, toluene 2,6-diisocyanate, toluene 2,4-diisocyanate, or a combination thereof; and
wherein the composition comprises
70 to 90 weight percent of the thermoplastic polyurethane; and
10 to 30 weight percent of the particulate engineering plastic.

17. An article comprising a composition comprising:
50 to 95 weight percent of a thermoplastic polyurethane; and
5 to 50 weight percent of a particulate engineering plastic;
wherein the particulate engineering plastic comprises a polyarylsulfone, a polyimide, a poly(phenylene sulfide), a semi-crystalline polyamide, or a combination thereof;
wherein the particulate engineering plastic has a glass transition temperature or a crystalline melting point greater than or equal to 200° C.;
wherein the particulate engineering plastic has a mean particle size of 5 to 1000 micrometers; and
wherein the weight percent values are based on the total weight of the composition.

18. The article of claim 17, selected from the group consisting of films, sheets, cable sheathing, spiral tubing, pneumatic tubing, blow molded bellows, ski boot shells, sport shoe soles, caster tires, belts for machinery, heat sealed textile lamination, automotive body panels, and automotive rocker panels.

19. The article of claim 17,
wherein the composition comprises the polyarylsulfone; wherein the polyarylsulfone comprises poly(1,4-phenylene ether-ether-sulfone) (CAS Reg. No. 28212-68-2);
wherein the particulate engineering plastic has a mean particle size of 5 to 600 micrometers;
wherein the thermoplastic polyurethane is the reaction product of reactants comprising
a polymeric diol comprising a polyether diol, a polyester diol, or a combination thereof, and
a diisocyanate comprising 2,4′-diphenylmethane diisocyanate, 4,4′-diphenylmethane diisocyanate, toluene 2,6-diisocyanate, toluene 2,4-diisocyanate, or a combination thereof, and
wherein the composition comprises
70 to 90 weight percent of the thermoplastic polyurethane; and
10 to 30 weight percent of the particulate engineering plastic.
